(19) United States
(12) Patent Application Publication
(10) Pub. No.: US 2012/0291906 A1
(43) Pub. Date: Nov. 22, 2012

(54) TUBE STRUCTURE FOR BICYCLE CABLE

(76) Inventor: Wayne-Ian Moore, CHANGHUA COUNTY (TW)

(21) Appl. No.: 13/569,175

(22) Filed: Aug. 7, 2012

Related U.S. Application Data
(63) Continuation-in-part of application No. 13/009,858, filed on Jan. 20, 2011.

(51) Int. Cl. F16M 13/00

(52) U.S. Cl. 138/134

(57) ABSTRACT

A tube structure for bicycle cable includes a rigid metallic member spirally wound into a tubular body. The tubular body has a channel centrally defined therein and axially extending therethrough for adapting to be passed through by a bicycle brake cable. A flexible metallic member is connected with the rigid metallic member and is spirally disposed along a length of the rigid metallic member. When the tubular body is impacted with an external force, the rigid metallic member provides an enhanced rigidity to the tubular body for preventing a deformation of the tubular body. The flexible metallic member and the rigid metallic member are alternately arranged so as to allow the tubular body to be bendable and have a sufficient ductility.

### CROSS-REFERENCE TO RELATED APPLICATION

This application is a Continuation-In-Part Application of Ser. No. 13/009,858, filed 20 Jan. 2011, and entitled “TUBE STRUCTURE FOR BICYCLE CABLE”, now pending.

### BACKGROUND OF THE INVENTION

1. Field of the Invention

The present invention relates to a tube structure for bicycle cable, and more particularly to a tube structure formed by spirally winding a rigid metallic member and a flexible metallic member for providing a flexible and ductile effect.

2. Description of Related Art

A conventional guide tube for bicycle brake cable in accordance with the prior art comprises a guide tube. A brake cable passes through the guide tube. The guide tube is formed by a flexible metallic inner layer and a hard metallic outer layer. The guide tube is able to be bent at a predetermined bending angle due to a flexibility provided by the inner layer. The hard metallic outer layer provides a hardness to strengthen the structure of the guide tube for preventing a deformation of the guide tube.

The conventional guide tube for bicycle brake cable is able to be bent at different bending angles. However, the hard metallic outer layer which circumferentially encloses the flexible metallic inner layer limits a ductility of the guide tube. As the brake cable quickly moves along the guide tube, the guide tube is unable to efficiently eliminate the vibration generated by a movement of the brake cable. Therefore, the guide tube is easy to be worn and a lifetime of the guide tube is reduced.

The present invention has arisen to mitigate and/or obviate the disadvantages of the conventional guide tube for bicycle brake cable.

### SUMMARY OF THE INVENTION

The main objective of the present invention is to provide an improved tube structure for bicycle cable.

To achieve the objective, the tube structure for bicycle cable includes a rigid metallic member which is an elongated sheet with a predetermined thickness. The rigid metallic member is spirally wound into a tubular body. The tubular body has a channel centrally defined therein and axially extending therethrough for adapting to be passed through by a bicycle brake cable or a bicycle shifter cable. The rigid metallic member has two grooves respectively defined in two longitudinal sides thereof and extending therealong; a flexible metallic member is connected with the rigid metallic member and spirally disposed along a length of the rigid metallic member. The flexible metallic member is a wire which has a circular cross section and corresponds to a shape of the grooves of the rigid metallic member for being received in the grooves. The rigid metallic member has a width relatively greater than a diameter of the flexible metallic member.

Accordingly, the tubular body is connected with a brake seat which is mounted on a bicycle. The bicycle brake cable passes through the channel of the tubular body so that the tubular body is substantially an outer tube relative to the bicycle brake cable. When the tubular body is impacted with an external force, the rigid metallic member provides an enhanced rigidity to the tubular body for preventing a deformation of the tubular body. And the flexible metallic member and the rigid metallic member are alternately arranged so as to allow the tubular body to be bendable and have a sufficient ductility.

Further benefits and advantages of the present invention will become apparent after a careful reading of the detailed description with appropriate reference to the accompanying drawings.

### BRIEF DESCRIPTION OF THE DRAWINGS

FIG. 1 is a partially assembled perspective view of a tube structure for bicycle cable in accordance with the present invention;

FIG. 2 is a partially cross sectional plan view of the tube structure for bicycle cable in accordance with the present invention;

FIG. 3 is a perspective view of the tube structure for bicycle cable in accordance with the present invention; and

FIG. 4 is an operational view of the tube structure for bicycle cable in accordance with the present invention as assembling with a bicycle seat.

### DETAILED DESCRIPTION OF THE INVENTION

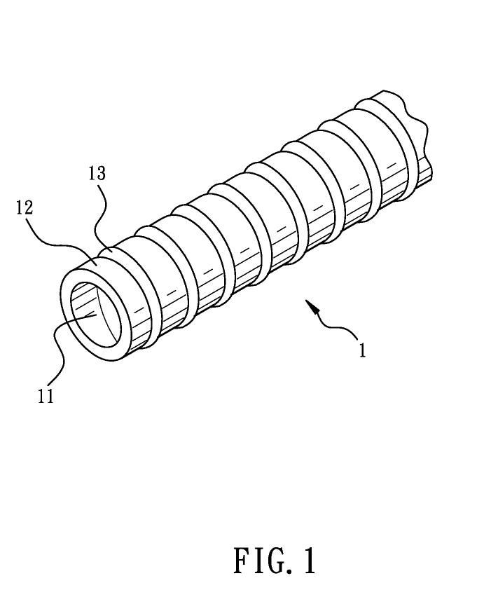

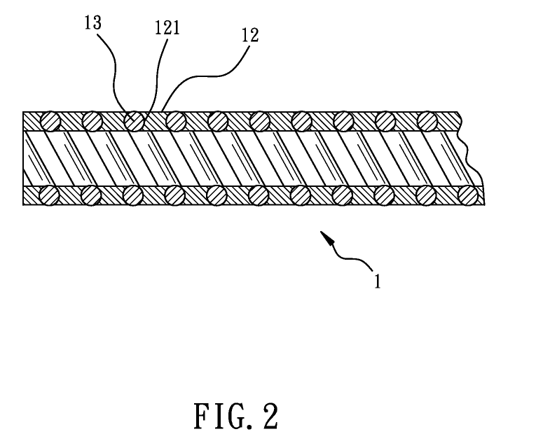

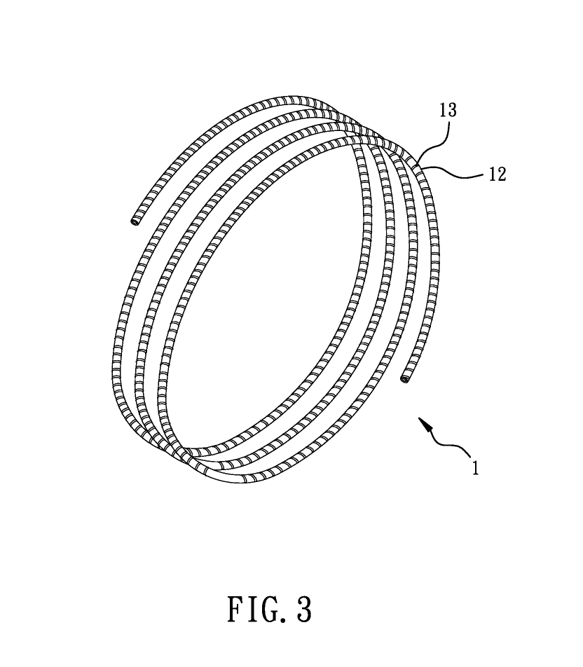

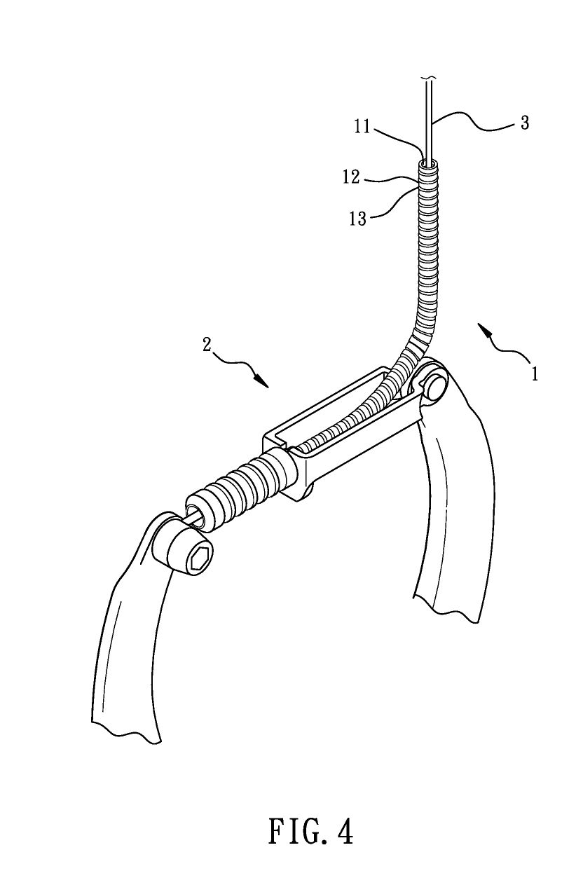

Referring to the drawings and initially to FIGS. 1-4, a tube structure for bicycle cable in accordance with a preferred embodiment of the present invention comprises a rigid metallic member 12 and a flexible metallic member 13 which is connected with the rigid metallic member 12. The rigid metallic member 12 is an elongated sheet with a predetermined thickness. The rigid metallic member 12 is spirally wound into a tubular body 1. The tubular body 1 has a channel 11 centrally defined therein and axially extending therethrough for adapting to be passed through by a bicycle brake cable 3 (shown in FIG. 4) or a bicycle shifter cable (not shown). The rigid metallic member 12 has two grooves 121 respectively defined in two longitudinal sides thereof. Each groove 121 extends along the corresponding longitudinal side of the rigid metallic member 12 to have a helical arrangement. Each groove 121 has a semi-circular cross section.

The flexible metallic member 13 is spirally disposed along a length of the rigid metallic member 12 and received in the helical-arranged grooves 121. The flexible metallic member 13 is a wire which has a circular cross section and corresponds to a shape of the grooves 121 of the rigid metallic member 12, such that a connection between the flexible metallic member 13 and the rigid metallic member 12 is substantially sealed. The rigid metallic member 12 has a width relatively greater than a diameter of the flexible metallic member 13 for relatively increasing a hardness of the tubular body 1.

Accordingly, when the tubular body 1 is impacted with an external force, the rigid metallic member 12 provides an enhanced rigidity to the tubular body 1 for preventing a deformation of the tubular body 1. The flexible metallic member 13 and the rigid metallic member 12 are alternately arranged so that the flexible metallic member 13 provides a flexibility to allow the tubular body 1 to be bendable and have a sufficient ductility.

The application of the tube structure for bicycle cable in accordance with the present invention will be described in detailed below. The tubular body 1 is connected with a brake seat 2 which is mounted on a bicycle (not shown). The bicycle brake cable 3 passes through the channel 11 of the tubular body 1 so that the tubular body 1 is substantially an outer tube relative to the bicycle brake cable 3. The bicycle brake cable 3 which is received in the tubular body 1 is bendable due to the flexibility provided by the flexible metallic member 13. When the bicycle brake cable 3 is operated to axially move along the channel 11, the tubular body 1 is able to prevent a non-axial displacement of the bicycle brake cable 3 relative to the tubular body 1, so that the motion of the bicycle brake cable 3 is smooth and a braking efficiency is optimized. And the bicycle brake cable 3 is sufficiently protected by the tubular body 1 which has the enhanced rigidity provided by the rigid metallic member 12. In addition, because the connection between the flexible metallic member 13 and the rigid metallic member 12 is substantially sealed, the tubular body 1 further prevents outside dust flowing into the channel 11 and dirtying the bicycle brake cable 3 therein. Therefore, the tubular body 1 not only protects the bicycle brake cable 3 from an impact of the external force, but also prevents the bicycle brake cable 3 from dirtying.

Therefore, the movement of the bicycle brake cable 3 is smoother and more efficient due to the alternate arrangement of the rigid metallic member 12 and the flexible metallic member 13. And the tubular body 1 has a relatively lighter weight than that of the conventional steel tube. Additionally, the tubular body 1 is able to be bent at a desired angle so as to fit in any kind of brake seat 2, The ductility of the tubular body 1 is optimized, such that tubular body 1 is able to eliminate the vibration of the bicycle brake cable 3 when the bicycle brake cable 3 quickly moves along the channel 11, So the lifetime of the tubular body 1 would become longer.

Although the invention has been explained in relation to its preferred embodiment, it is to be understood that many other possible modifications and variations can be made without departing from the spirit and scope of the invention as hereinafter claimed.

What is claimed is:

1. A tube structure for bicycle cable comprising:
a rigid metallic member spirally wound into a tubular body, the tubular body having a channel centrally defined therein and axially extending therethrough for adapting to be passed through by a bicycle brake cable; and
a flexible metallic member connected with the rigid metallic member and spirally disposed along a length of the rigid metallic member;
whereby, the tubular body is connected with a brake seat which is mounted on a bicycle; the bicycle brake cable passes through the channel of the tubular body so that the tubular body is substantially an outer tube relative to the bicycle brake cable; when the tubular body is impacted with an external force, the rigid metallic member provides an enhanced rigidity to the tubular body for preventing a deformation of the tubular body; the flexible metallic member and the rigid metallic member are alternately arranged so as to allow the tubular body to be bendable and have a sufficient ductility.

2. The tube structure for bicycle cable as claimed in claim 1, wherein the rigid metallic member is an elongated sheet with a predetermined thickness and the flexible metallic member is a wire having a circular cross section, the rigid metallic member having two grooves respectively defined in two longitudinal sides thereof and extending therealong, each groove having a shape corresponding to the flexible metallic member for receiving the flexible metallic member.

3. The tube structure for bicycle cable as claimed in claim 1, wherein the rigid metallic member has a width which is greater than a diameter of the flexible metallic member.
